(19) United States
(12) Patent Application Publication
(10) Pub. No.: US 2012/0124471 A1
(43) Pub. Date: May 17, 2012

(54) Virtual tour, display and commerce

(76) Inventors: Jeffrey S. Gusky, Dallas, TX (US); Chris Centers, Coppel, TX (US); Joshua Weatherspoon, Dallas, TX (US)

(21) Appl. No.: 13/200,299

(22) Filed: Sep. 22, 2011

Related U.S. Application Data
(60) Provisional application No. 61/403,902, filed on Sep. 23, 2010.

(51) Int. Cl. G06F 3/048

(52) U.S. Cl. 715/705

(57) ABSTRACT

A virtual tour and display begins with an initial view of a start location. The user navigates by clicking on navigational arrows located on the various spaces, such as halls or galleries or store areas, in each case initiating an animated movie which either turns the user within the same space or goes to a different location within the same space or by moving to a different space. A user can move to a gallery, which displays thumbnail images, such as a pictures on a wall, or clothing on a wall or rack or other items to be viewed. The user can select one of the thumbnail images, such as a picture to be viewed and have a full screen view of the selected image or hear an audio clip about the selected image, or other options.

### CROSS-REFERENCE TO RELATED APPLICATIONS

### Statement Regarding Federally Sponsored Research or Development

Not Applicable

### Incorporation-by-Reference of Material Submitted on a Compact Disc

Not Applicable

### BACKGROUND OF THE INVENTION

1. Field of the Invention

The present invention is generally in the field of virtual tours and online commerce, and in particular, a virtual tour and commerce with virtual motion.

2. Description of Related Art

Action video games have continual motion, and as a result, use vast amounts of random access memory, RAM, and processor time. So called virtual tours, such as for a house for sale, are actually a series of photographs, with no real motion. These virtual tours give a good impression of the features of the house, but not a feel of actually walking through the house.

The present invention gives a virtual tour with a series of photographs or drawings connected by short animated movies that give the sense and feel of actually moving through the tour space. This is done in a way that does not make huge demands on processor time and RAM.

### BRIEF SUMMARY OF THE INVENTION

A virtual tour and display according to the present invention, in a preferred form, is online in a computer network such as the world wide web. The virtual tour and display begins with a computer display of an initial view, in the case illustrated, the initial view is start—facing north from outside of the Main Hall doors. A user initiates each move, in the present case by clicking somewhere on start—facing north from outside of the Main Hall doors, the first move being an animated movie, open the doors and move forward to Main Hall position 01. When the user initiates this move, it activates a short animated movie and ends at another display, in the case illustrated Main Hall position 02, facing north. An animated movie can be a flash animation or an animated movie such as associated with HTML5. The user continues to navigate through the virtual tour by clicking on navigational arrows located on the various spaces, such as halls or galleries or store areas, in each case initiating an animated movie which either turns the user within the same space, giving a different view or by moving to a different space. The use of the term “animated movie” is used here in a broad sense and would include animated 3-D movies and holographic movies. In such a case, it would also be preferred for the associated end views to also be in 3-D or holographic.

At some point during the tour, a user moves to a gallery, which displays thumbnail images, such as a pictures on a wall, or clothing on a wall or rack or other items to be viewed. At this point, the user has a different kind of choice. The user can initiate animated movie by clicking an arrow to rotate right or left to see other images or the user can select one of the thumbnail images, such as a picture to be viewed and have a full screen view of the selected image. At that point, for the user to return to the prior gallery view, the user must click on the full screen view of the selected image.

Once a selection is made from the various images, in this case of pictures such as paintings or water colors or photographs, a user has further options. Options include pressing or clicking an audio button adjacent to the full screen selected image to hear an audio clip about the selected image, or pressing or clicking a text button adjacent to full screen selected image to see text and a caption about the selected image or to press or click a purchase button adjacent to full screen image for online purchase by means of an online e-commerce web page and a shopping cart.

The present invention is not limited to the particular order of views and the connecting animated movies or to the particular illustrated halls, galleries and images. Rather than an online tour of an art gallery, the present invention could be used for online purchase of clothes from racks or could be used for a virtual tour of other types of places such as a museum, shopping mall, car dealership, hotel, casino, stadium, airplane cockpit, submarine interior or historic place.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a flow diagram of a sample tour and display according to the present invention;

FIG. 2 is a Start according to the present invention, facing north from outside of the Main Hall doors, of the flow diagram of FIG. 1;

FIG. 3 is a Main Hall Position 01 according to the present invention, facing north, of flow diagram of FIG. 1

FIG. 4 is a Main Hall Position 02 according to the present invention, facing north, of the flow diagram of FIG. 1;

FIG. 5 is a Main Hall Position 03 according to the present invention, facing north, of the flow diagram of FIG. 1;

FIG. 6 is a Main Hall Position 02 according to the present invention, facing west, of the flow diagram of FIG. 1;

FIG. 7 is a Silent Places Gallery 01 according to the present invention, facing west, of the flow diagram of FIG. 1;

FIG. 8 is a Full Screen View according to the present invention of a selected image;

FIG. 9 is a flow diagram of a sample commerce according to the present invention;

FIG. 10 is a flow diagram for a map selection according to the present invention; and

FIG. 11 is full screen three dimensional map of the tour area of FIG. 1, according to the present invention.

### DETAILED DESCRIPTION OF THE INVENTION

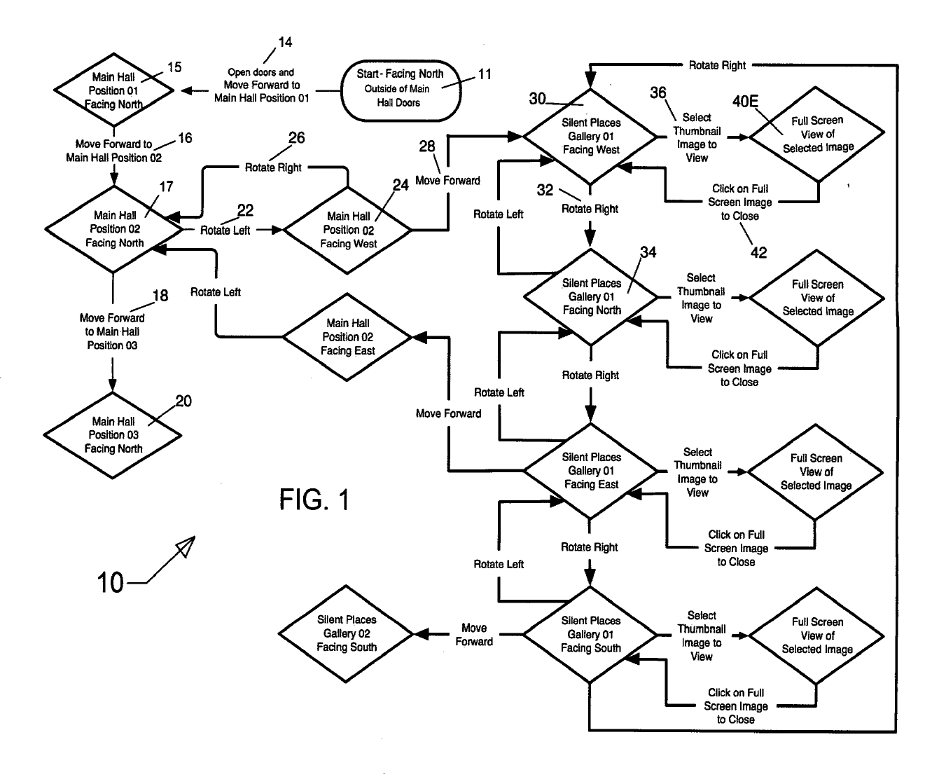

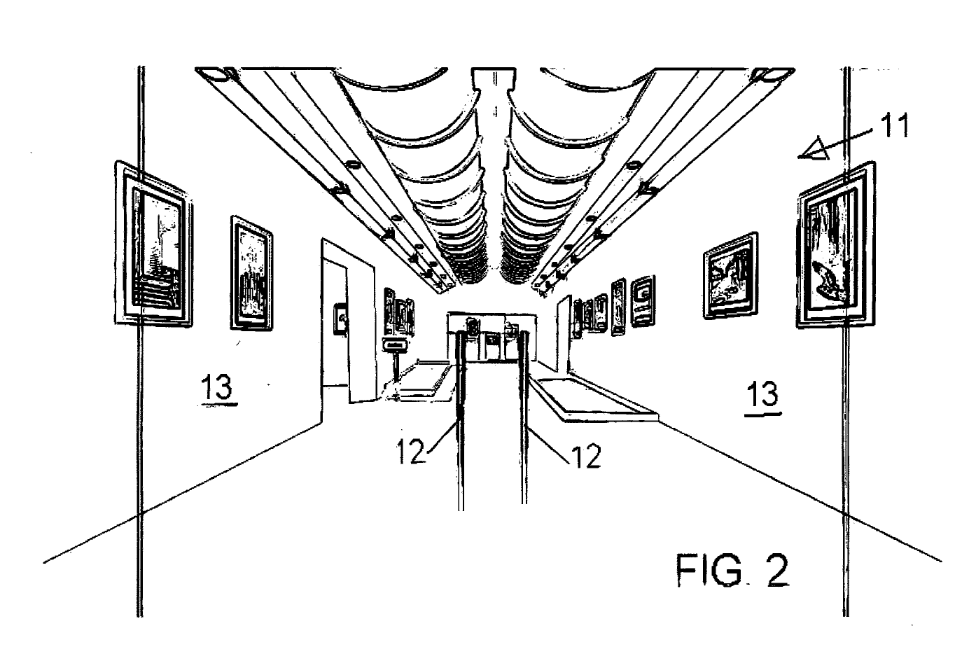

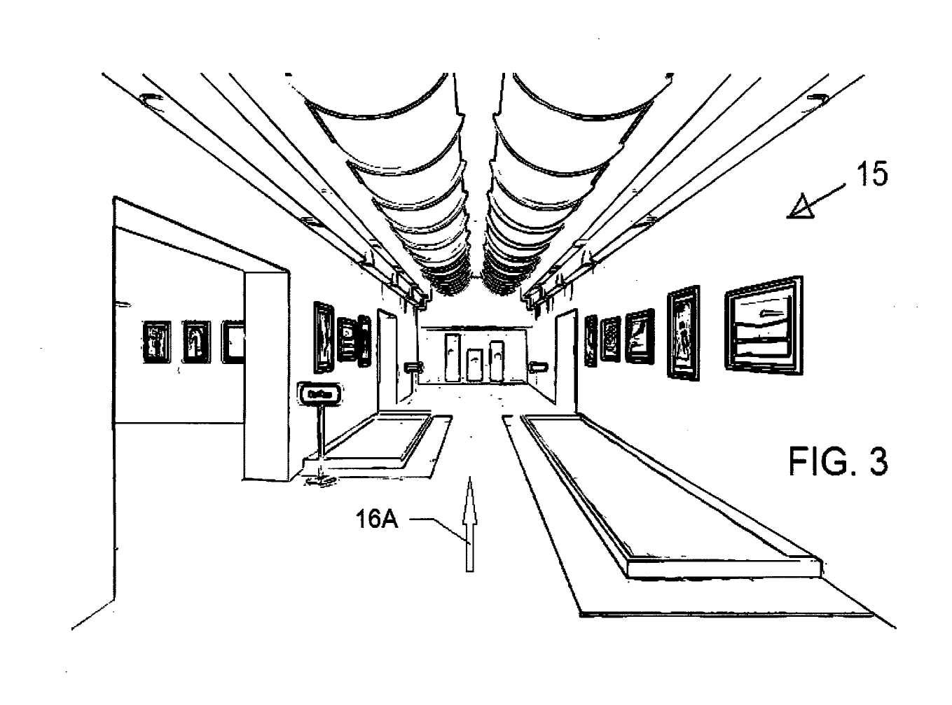

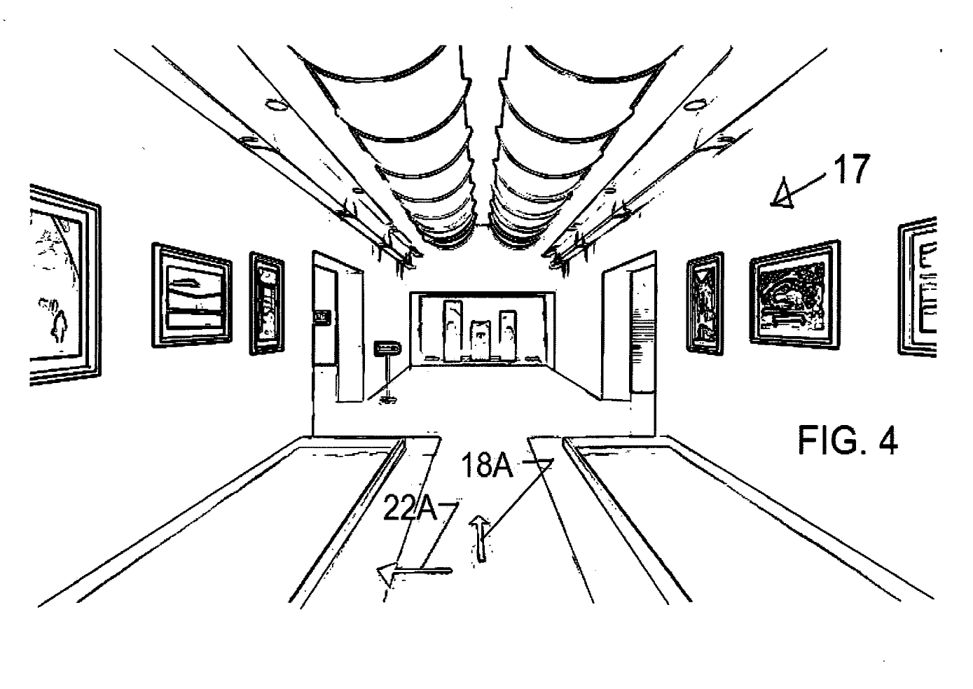

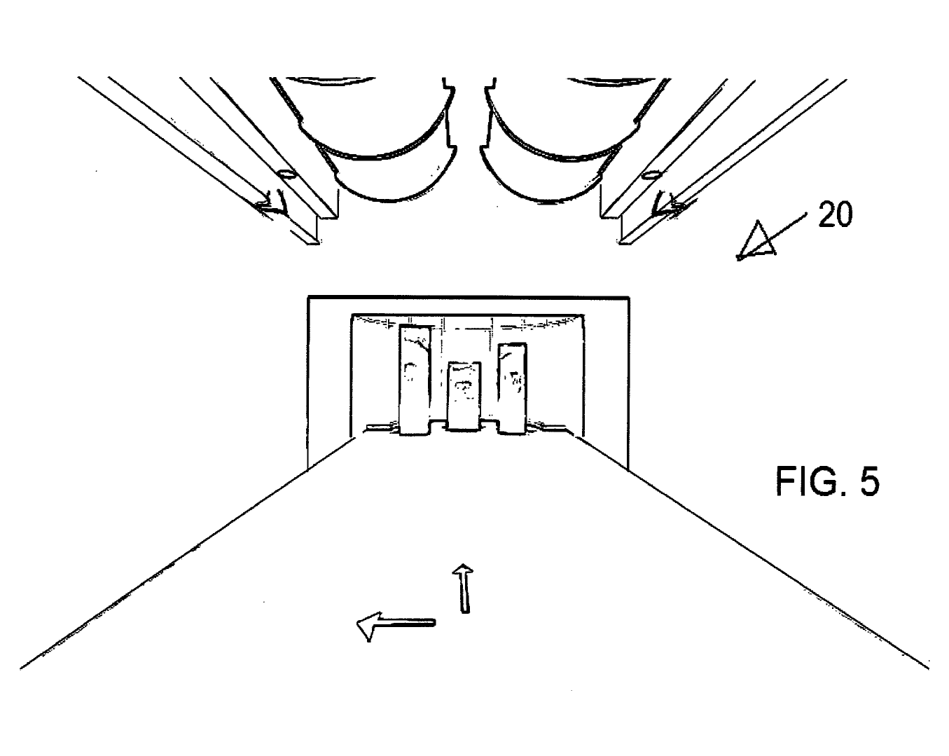

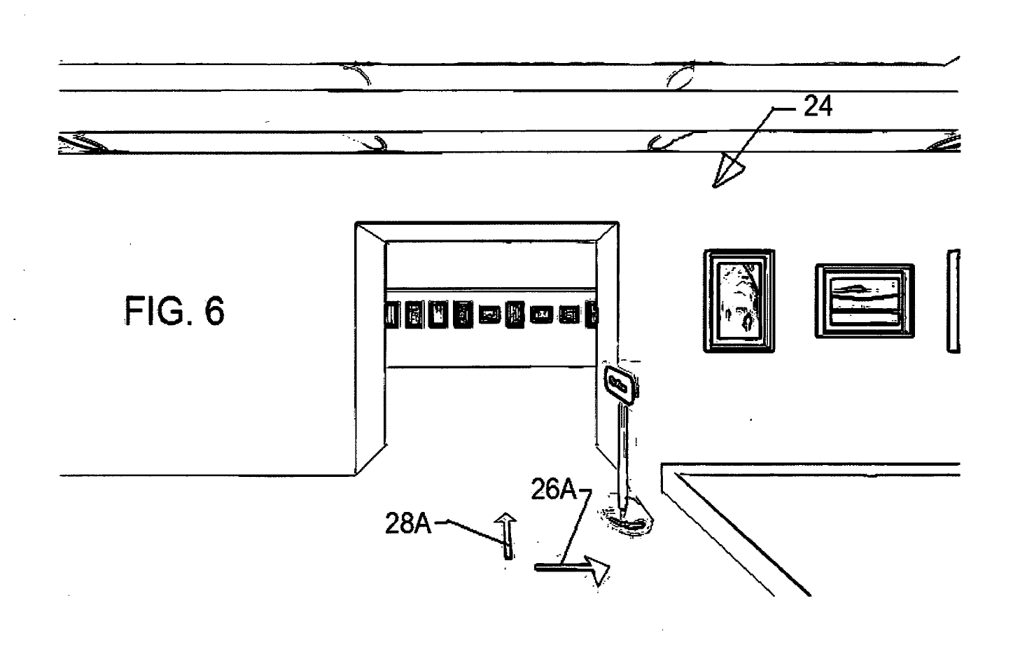

Referring now to the drawing, and in particular to FIG. 1, a virtual tour and display according to the present invention is represented generally by reference numeral 10. Virtual tour 10, in a preferred form, is online in a computer network such as the world wide web. In other forms, it could be downloaded directly to a computer and run from that computer. In either of these forms, the moves are initiated by a user from the user's computer. Referring also to FIG. 2 and FIG. 3, virtual tour and display 10 begins with a computer display of an initial view, in the case illustrated, the initial view is start—facing north from outside of the Main Hall doors 11. By clicking on door handles 12 or anywhere on doors 13, the first animated movie 14 which opens doors 13 and moves forward to Main Hall position 01, facing north 15. A user initiates each move, in the present case by clicking on an arrow 16A on Main Hall position 01—facing north 15, the move being an animated movie 16, virtually moving forward to Main Hall position 02. When the user initiates this move, it activates a short animated movie and ends at another display, in the case illustrated Main Hall position 02, facing north 17. An animated movie can be a flash animation or an animated movie such as associated with HTML5. Animated movie 16 gives the user the visual, and therefore the feel, of actually moving forward in the Main Hall. Referring also to FIGS. 4 through 6, from Main Hall position 02, the user has a choice, to initiate animated movie 18 move forward to Main Hall position 03 facing north 20, by clicking arrow 18A or animated movie 22 to Main Hall position 02 facing west 24, by clicking arrow 22A. Just as animated movie 16 and animated movie 18 give the user the actual visual of moving forward in the Main Hall, animated movie 22 gives the user the actual visual of turning to the left.

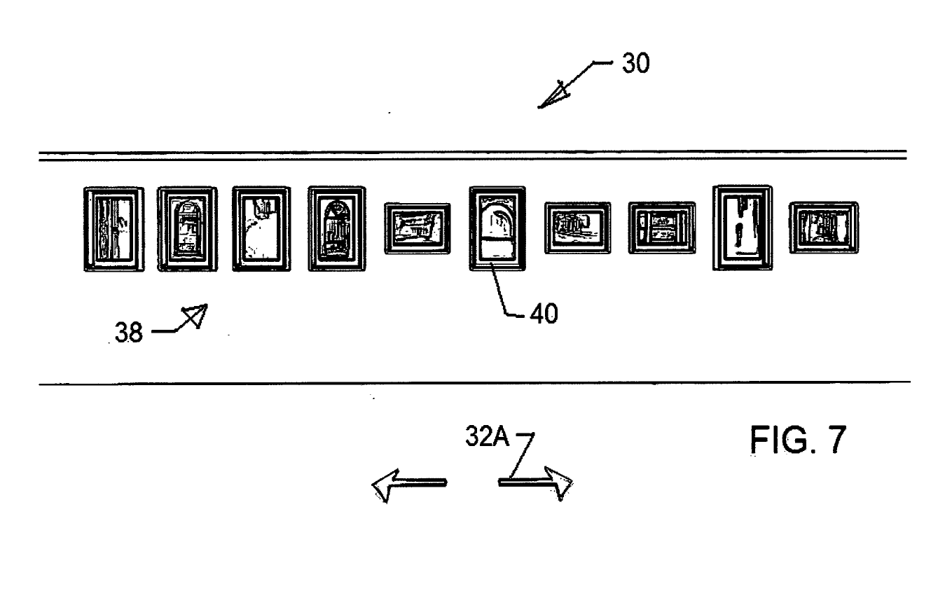

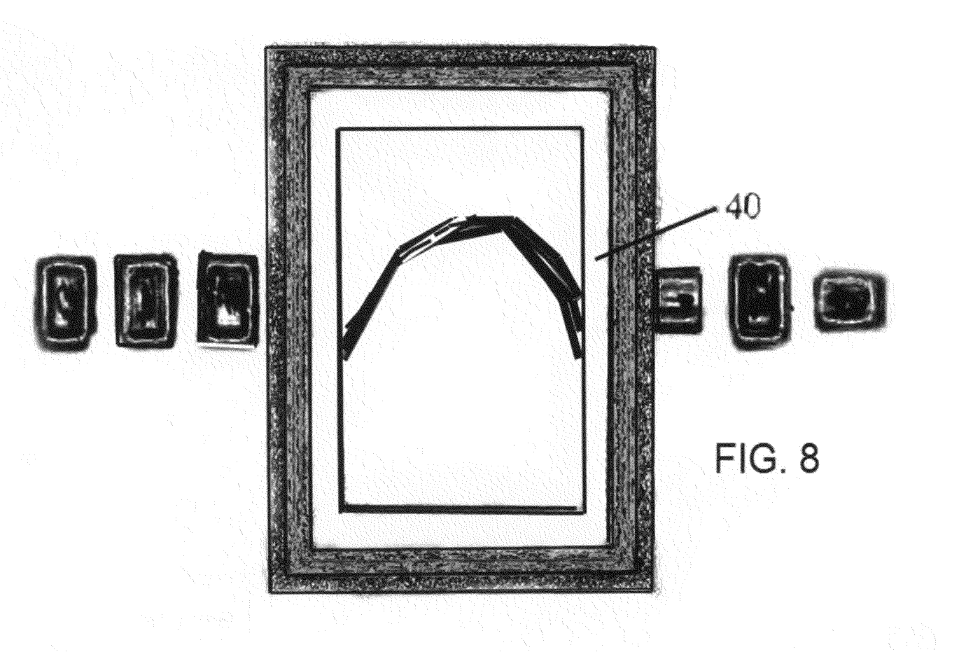

Referring now to FIG. 7 and FIG. 8, once in Main Hall position 02 facing west 24, the user has the option of initiating animated movie 26 rotate right by clicking arrow 26A, returning to Main Hall position 02 facing north 17 or animated movie 28 by clicking arrow 28A move forward to Silent Places Gallery 01 facing west 30. Silent Places Gallery displays thumbnail images, such as a pictures on a wall, or clothing on a wall or rack or other items to be viewed. At this point, the user has a different kind of choice. The user can initiate animated movie 32 by clicking arrow 32A rotate right to Silent Places Gallery 01 facing north 34, or the user can select 36 one of the thumbnail images 38, such as a picture to be viewed and have a full screen view of the selected image 40. At that point, for the user to return to Silent Places Gallery 01 facing west 30, the user must click 42 on the full screen or enlarged view 40E of the selected image 40. The remainder of virtual tour 10 operates in a similar manner to those described in detail.

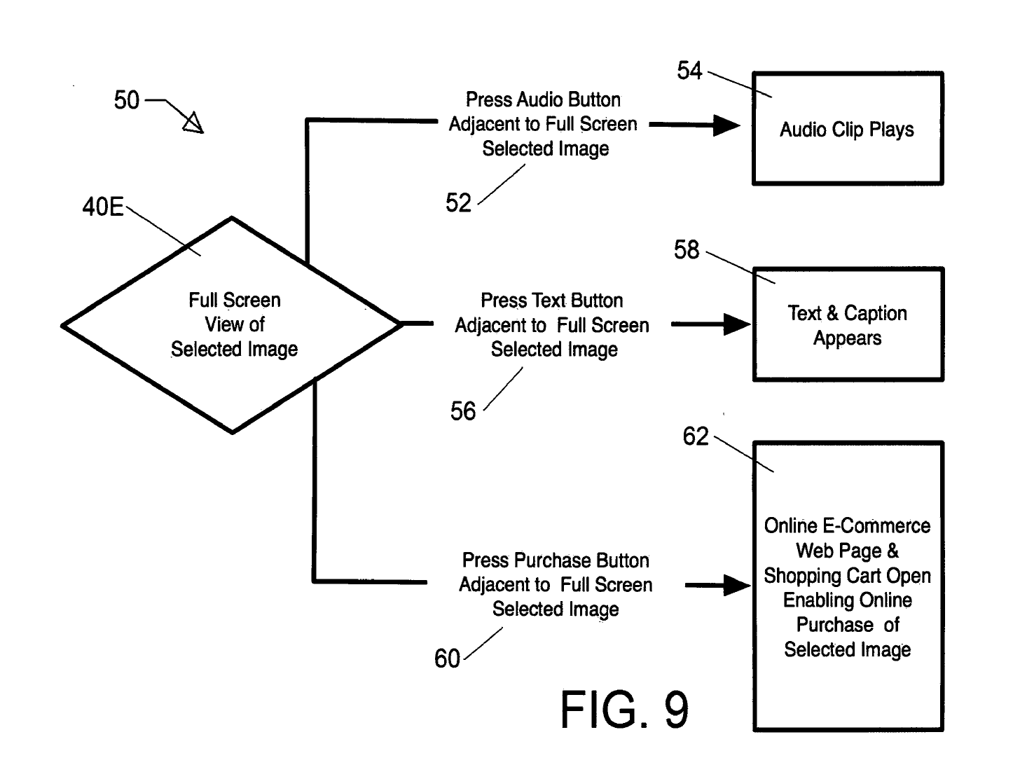

Referring now to FIG. 9, once a selection is made from the various images, in this case of pictures such as paintings or water colors or photographs, a user has further options referred to generally by reference numeral 50. Options 50 include pressing or clicking 52 an audio button adjacent to full screen or enlarged image 40E to hear an audio clip 54 about the selected image, or pressing or clicking 56 a text button adjacent to full screen or enlarged image 40E to see text and caption 58 about the selected image or to press or click 60 a purchase button adjacent to full screen or enlarged image 40E for online purchase 62 by means of an online e-commerce web page and a shopping cart.

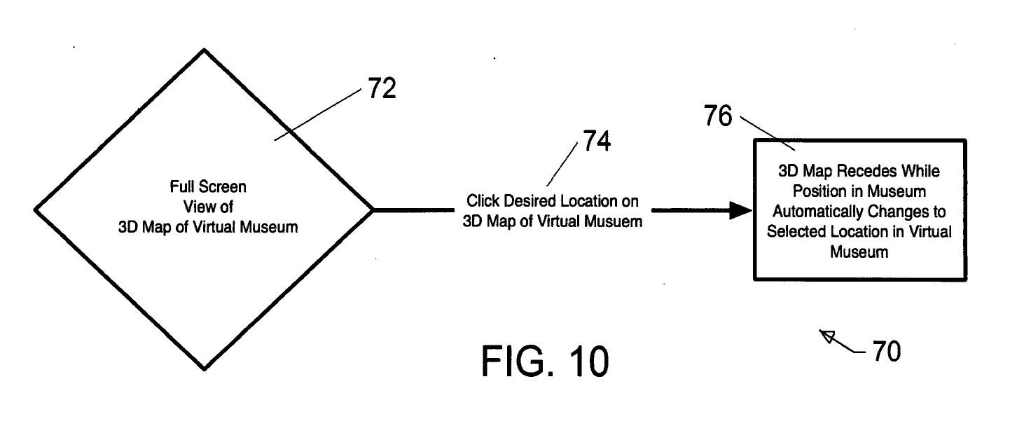

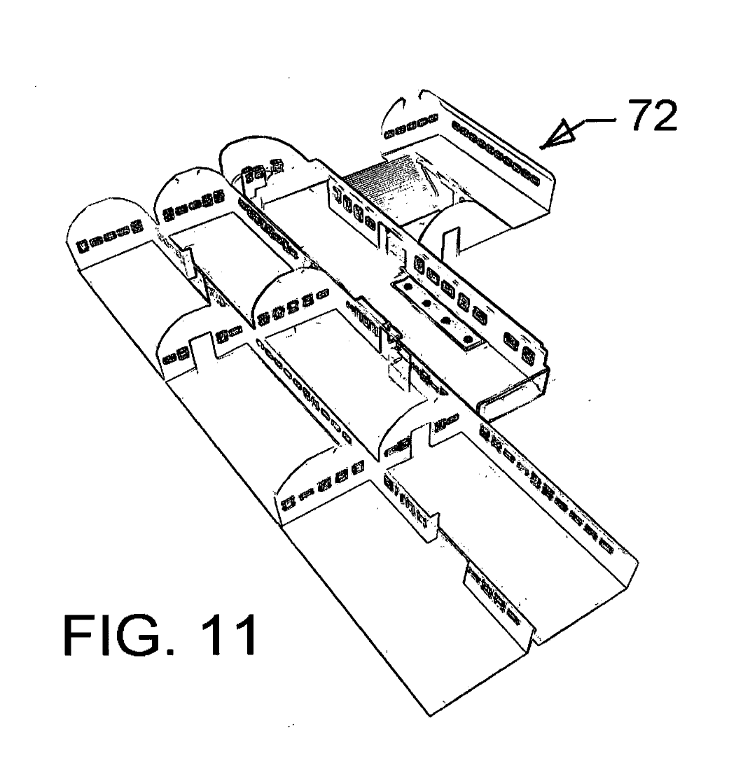

Referring now to FIG. 10 and FIG. 11, an alternative navigation method is referred to generally by reference numeral 70. Alternative navigation method 70, allows a full screen view of a map of the entire tour area 10, in the present case, the entire gallery. In a preferred form, the map would be a full screen view of a three dimensional map 72. Such a three dimensional map 72, in a preferred form, would automatically appear just before motion stops at Main Hall position 01, facing north 15. Alternatively, three dimensional map 72 could be activated by a user by clicking an icon at any time. Once three dimensional map 72 appears, the user then clicks 74 a desired location on three dimensional map 72 and is either automatically transferred 76 to the selected location or is rapidly moved by the most direct route through tour 10.

The present invention is not limited to the particular order of views and the connecting animated movies or to the particular illustrated halls, galleries and images. Rather than an online tour of an art gallery, the present invention could be used for online purchase of clothes from racks or could be used for a virtual tour of other types of places such as a museum, shopping mall, car dealership, hotel, casino, stadium, airplane cockpit, submarine interior or historic place.

It can now be seen that a virtual tour, according to the present invention, for operation on a computer or a network of computers having at least one computer generated display or other audio visual device and guided by a user, includes displaying an initial view of a first location on the display or other audio visual device, and showing one or more navigational symbols on the display of the initial view. Each navigational symbol is clickable by the user, associating a different animated movie with each of the at least one navigational symbols. The user clicking on a particular navigational symbol will activate the associated animated movie, and associating a first set of end views, associating a different end view with each animated movie to correspond to the end view of the animated movie.

In a preferred form, the one or more navigational symbols and associated movies and associated end views are from the group including: turning left a predetermined angle, turning right a predetermined angle, going forward within the same location, going forward into second location and backing up within the same location. The locations in the embodiment illustrated are rooms within a building. A sound clip can be associated with a view or with an animated movie.

In a preferred form, a virtual tour according to the present invention, further including the steps of: showing one or more navigational symbols on the display of each end view of the first set of end views, wherein each navigational symbol is clickable by the user, associating a different animated movie with each of the at least one navigational symbols, wherein the user clicking on a particular navigational symbol will activate the associated animated movie; and associating second set of end views, associating a different end view with each animated movie to correspond to the end view of the animated movie.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A virtual tour for operation on a computer or a network of computers having at least one computer generated display or other audio visual device and guided by a user, comprising, in combination:
displaying an initial view of a first location on the display or other audio visual device;
showing one or more navigational symbols on the display or other audio visual device of the initial view, wherein each navigational symbol is clickable by the user;
associating a different animated movie with each of the at least one navigational symbols, wherein the user clicking on a particular navigational symbol will activate the associated animated movie; and
associating a first set of end views, associating a different end view with each animated movie to correspond to the end view of the animated movie.

2. A virtual tour for operation on a computer or a network of computers having at least one computer generated display or other audio visual device and guided by a user, according to claim 1, wherein the one or more navigational symbols and associated movies and associated end views are from the group including:
turning left a predetermined angle;
turning right a predetermined angle;
going forward within the same location;
going forward into second location; and
backing up within the same location.

3. A virtual tour for operation on a computer or a network of computers having at least one computer generated display or other audio visual device and guided by a user, according to claim 2, wherein the animated movies are flash animations.

4. A virtual tour for operation on a computer or a network of computers having at least one computer generated display or other audio visual device and guided by a user, according to claim 2, wherein the animated movies are associated with HTML5.

5. A virtual tour for operation on a computer or a network of computers having at least one computer generated display or other audio visual device and guided by a user, according to claim 2, wherein the locations are rooms within a building.

6. A virtual tour for operation on a computer or a network of computers having at least one computer generated display or other audio visual device and guided by a user, according to claim 5, further including the step of associating at least one thumbnail image with at least one of the displayed views, whereby the at least one thumbnail image can be clicked on to enlarge the image shown.

7. A virtual tour for operation on a computer or a network of computers having at least one computer generated display or other audio visual device and guided by a user, according to claim 6, further including the step of associating a sound clip with a view or with an animated movie.

8. A virtual tour for operation on a computer or a network of computers having at least one computer generated display or other audio visual device and guided by a user, according to claim 1, further including the steps of:
showing one or more navigational symbols on the display or other audio visual device of each end view of the first set of end views, wherein each navigational symbol is clickable by the user;
associating a different animated movie with each of the at least one navigational symbols, wherein the user clicking on a particular navigational symbol will activate the associated animated movie; and
associating second set of end views, associating a different end view with each animated movie to correspond to the end view of the animated movie.

9. A virtual tour for operation on a computer or a network of computers having at least one computer generated display or other audio visual device and guided by a user, according to claim 1, wherein the animated movies are flash animations.

10. A virtual tour for operation on a computer or a network of computers having at least one computer generated display or other audio visual device and guided by a user, according to claim 1, wherein the animated movies are associated with HTML5.

11. A virtual tour for operation on a computer or a network of computers having at least one computer generated display or other audio visual device and guided by a user, according to claim 1, wherein the locations are rooms within a building.

12. A virtual tour for operation on a computer or a network of computers having at least one computer generated display or other audio visual device and guided by a user, according to claim 11, further including the step of associating at least one thumbnail image with at least one of the displayed views, whereby the at least one thumbnail image can be clicked on to enlarge the image shown.

13. A virtual tour for operation on a computer or a network of computers having at least one computer generated display or other audio visual device and guided by a user, according to claim 12, further including the step of associating a sound clip with a view or with an animated movie.

14. A virtual tour for operation on a computer or a network of computers having at least one computer generated display or other audio visual device and guided by a user, according to claim 13, wherein the virtual tour is a virtual tour of a museum.

15. A virtual tour for operation on a computer or a network of computers having at least one computer generated display or other audio visual device and guided by a user, according to claim 13, wherein the virtual tour is a virtual tour of a store or other shopping area.

16. A virtual tour for operation on a computer or a network of computers having at least one computer generated display or other audio visual device and guided by a user, according to claim 13, wherein the virtual tour is a virtual tour of one or more historic places or events.

17. A virtual tour for operation on a computer or a network of computers having at least one computer generated display or other audio visual device and guided by a user, according to claim 1, wherein the virtual tour is a virtual tour of a museum.

18. A virtual tour for operation on a computer or a network of computers having at least one computer generated display or other audio visual device and guided by a user, according to claim 1, wherein the virtual tour is a virtual tour of a store or other shopping area.

19. A virtual tour for operation on a computer or a network of computers having at least one computer generated display or other audio visual device and guided by a user, according to claim 1, wherein the virtual tour is a virtual tour of one or more historic places or events.
